(19) United States
(12) Patent Application Publication
(10) Pub. No.: US 2001/0032062 A1
(43) Pub. Date: Oct. 18, 2001

(54) System, method and computer program product for designing, specifying purchasing and constructing a renovation project online

(76) Inventors: Matthew Plaskoff, Tarzana, CA (US); Randy Plaskoff, Tarzana, CA (US)

Correspondence Address: VENABLE, Post Office Box 34385, Washington, DC, 20043-9998, US

(21) Appl. No.: 09/756,848

(22) Filed: Jan. 10, 2001

Related U.S. Application Data
(60) Provisional application No. 60/174,904, filed on Jan. 10, 2000.

(51) Int. Cl. G06F 17/50

(52) U.S. Cl. 703/1

(57) ABSTRACT

A system, method and computer program product for designing, specifying, and purchasing over the Internet, and for constructing a construction renovation project is provided by the present invention. In embodiment of the invention, a method can include receiving a renovation order for a construction renovation project from a customer at an Internet interface, where the renovation order is prepared by the customer including designing, specifying, and purchasing the project via the Internet interface, delivering materials specified in the renovation order and needed to perform the construction renovation project to a renovation location specified in the construction renovation project renovation order, and performing construction services of the construction renovation project as specified in the renovation order at the renovation location.

### CROSS-REFERENCE TO RELATED APPLICATION

The following application of common assignee may contain common disclosure with the present application:

Provisional U.S. Patent Application Ser. No. 60/174,904 entitled “System, Method and Computer Program Product for Designing, Specifying, Purchasing and Constructing a Renovation Project Online,” to Plaskoff, filed Jan. 10, 2000, Attorney Docket No. 36812/162281 (formerly A-21758), the contents of which are are incorporated herein by reference in their entireties.

### BACKGROUND OF THE INVENTION

1. Field of the Invention

The present invention relates generally to construction renovation systems and more particularly to online construction renovation systems.

2. Related Art

Construction renovation projects such as, e.g., a bathroom or kitchen, are often performed by a contractor for a customer. Conventionally, a customer meets with a contractor to request a quote for a renovation of, e.g., a bathroom. Such a meeting can occur onsite at the location of the prospective renovation or at the contractor location. In a typical meeting, the customer can discuss the customer's desires for the renovation. Conventionally, the contractor then needs to visit the construction site in order to measure the dimensions of the room. Follow-up meetings are usually necessary to select materials, such as, e.g., tile, fixtures and cabinetry. Eventually a rice quote can be prepared by the contractor for the customer. Unfortunately for the customer, the conventional process of getting a price quote for a renovation project can take a substantial amount of time and the costs of design and material selection can lead to a price that is not cost effective. Unfortunately for the contractor, the customer may reconsider performing the renovation resulting in a loss of the investment of time and money by the contractor. It is desirable that an improved system for designing, specifying, purchasing and constructing construction renovation services be provided that overcomes the limitations of conventional techniques.

### SUMMARY OF THE INVENTION

A system, method and computer program product for designing, specifying, purchasing and for constructing a construction renovation project is provided by the present invention.

In an exemplary embodiment of the invention, a method can include receiving a renovation order for a construction renovation project from a customer, where the renovation order is prepared by the customer including designing, specifying, and purchasing the project, delivering materials specified in the renovation order and needed to perform the construction renovation project to a renovation location specified in the construction renovation project renovation order, and performing construction services of the construction renovation project as specified in the renovation order at the renovation location.

In one exemplary embodiment of the invention, the renovation order is created by the customer at an Internet interface. In one embodiment, the Internet interface includes a world wide web Internet browser.

In another exemplary embodiment of the invention, the renovation order is created by the customer by filling out a packet questionnaire.

In one exemplary embodiment of the present invention, the method can further include completing the construction renovation project at a fixed price.

In another exemplary embodiment of the present invention, the method can further include completing the construction renovation project within a set time period or providing an award.

In one exemplary embodiment of the present invention, the construction renovation project can be for a bathroom. In one embodiment of the present invention, the method can include a set time period of about one week or less. In one embodiment of the present invention, an award can include a discount equivalent to the cost of a toilet. In one embodiment of the present invention, the fixed price can be approximately $7,500 or less.

In one exemplary embodiment of the present invention, the construction renovation project can be for a kitchen. In one embodiment of the present invention, the method can include a set time period of two weeks. In one embodiment of the present invention, the method can include the award of a discount equivalent to the cost of a sink. In one embodiment of the present invention, the method can include a fixed price of $25,000.

In another exemplary embodiment of the invention, a system, method, and computer program product for guiding a prospective renovation construction customer through a room design process using a room finder expert system, wherein the design process can include a series of questions regarding the room design is provided by the present invention. In one embodiment of the invention, the method can include asking questions relevant to the room design, receiving selections of answers to the questions from the customer, analyzing the selections of answers from the customer using a room finder expert system, asking any additional questions relevant to the room design, and determining one or more recommendations of the room design for the customer.

In one exemplary embodiment of the invention, the room design can be for designing a bathroom or a kitchen.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 depicts an exemplary embodiment of a flow diagram of a conventional renovation construction project process that can be used according to the present invention;

FIGS. 2A and 2B, collectively, depict an exemplary embodiment of a flow diagram of an improved renovation construction project process according to the present invention;

FIG. 3 depicts an exemplary embodiment of a graphical user interface (GUI) illustrating an exemplary renovation design website according to the present invention;

FIG. 4 depicts an exemplary embodiment of a GUI illustrating an exemplary renovation design process of an exemplary implementation according to the present invention;

FIG. 5 depicts an exemplary embodiment of a GUI illustrating a first step of choosing a floorplan an exemplary renovation design process of an exemplary implementation according to the present invention;

FIG. 6 depicts an exemplary embodiment of a GUI illustrating a second step of choosing a doorway location of an exemplary renovation design process of an exemplary implementation according to the present invention;

FIG. 7 depicts an exemplary embodiment of a GUI illustrating a third step of providing an interactive decision support system for providing a customized renovation design according to user preferences using an exemplary Bathfinder process of an exemplary implementation according to the present invention;

FIG. 8 depicts an exemplary embodiment of a GUI illustrating a fourth step of providing an exemplary selection of three alternative design renderings of an exemplary renovation design process of an exemplary implementation according to the present invention;

FIG. 9 depicts an exemplary embodiment of a GUI illustrating a fifth step of allowing user modification of an exemplary renovation design of an exemplary implementation according to the present invention;

FIG. 10 depicts an exemplary embodiment of a GUI pop-up window illustrating selecting alternate sinks from a catalog of choices of an exemplary implementation renovation design system according to the present invention;

FIG. 11 depicts an exemplary embodiment of a GUI illustrating a help resource including a frequently asked question window of an exemplary implementation according to the present invention;

FIG. 12 depicts an exemplary embodiment of a GUI illustrating a help resource providing a guaranteed cost and time duration that can be determined by user location of an exemplary implementation according to the present invention; and

FIG. 13 depicts an exemplary embodiment of a GUI illustrating a purchasing web form that can capture customer information that can capture a customer order and prompt scheduling of an initial visit using an exemplary implementation according to the present invention.

### DETAILED DESCRIPTION OF THE INVENTION

A preferred embodiment of the invention is discussed in detail below. While specific implementations are discussed, it should be understood that this is done for illustration purposes only. A person skilled in the relevant art will recognize that other components and configurations may be used without parting from the spirit and scope of the invention.

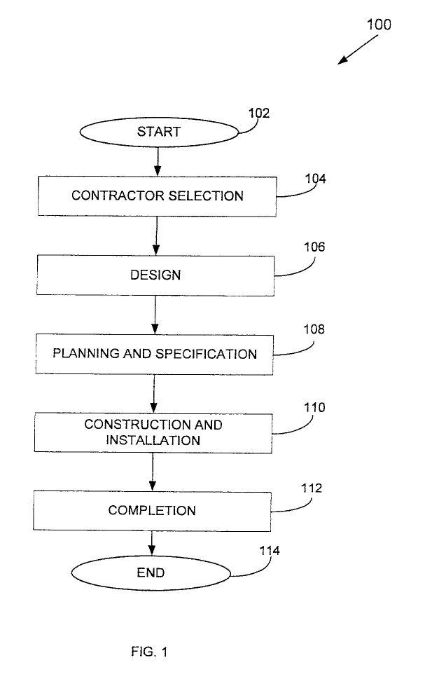

FIG. 1 depicts a flow diagram 100 of an example embodiment of a conventional renovation construction project process.

Renovation of a home, also commonly known as remodeling, can allow a customer to customize rooms of the home to better fit the needs of the customer, while permitting the customer to remain in the home. The customer usually can keep the basic structure intact, while improving the function and traffic flows of the home. Renovation construction projects can include renovating particular rooms such as, e.g., a bathroom or a kitchen, and can also include adding an addition to a home.

The example embodiment of the conventional renovation construction process illustrated in flow diagram 100, begins with step 102 and can continue immediately with step 104. In step 104, a contractor can be selected. Conventionally, a customer can begin by choosing a contractor with which to work. Some construction contractors can have showrooms allowing the customer to look at samples of their work, and to talk to their contractors and designers. Unfortunately, showrooms are expensive to establish and maintain. Also contractor meetings with unqualified prospect customers can be time consuming and expensive.

When the customer first visits a showroom, a contractor can spend time with the customer discussing what the customer hopes to achieve with the renovation project and can explain the renovation process to the customer. If the customer and the contractor feel that there is the basis for a good working relationship, the contractor can arrange to visit the customer home to determine the dimensions of the space, and to calculate a rough estimate of the total cost of such a project. From step 104, flow diagram 100 can continue with step 106.

Step 106 can include a design process. Once the customer has chosen a contractor, the customer typically enters into some form of contractual arrangement for completion of the design phase of the project. The fees for design can vary from a few hundred dollars to as much as 10% of the projects value. At this point the contractor typically begins actually planning and preparing specifications of the customer project.

The contractor can prepare “as built” drawings of the existing spaces to be impacted by the customer renovation project and the contractor can work up alternative designs to review with the customer. At this point, some preliminary decisions can often be made concerning cabinet styling, appliance types and general specifications. This process can take substantial time and interaction between the contractor and customer.

Once the design is finalized, actual floor plans and elevations can be prepared by the contractor and products which are to be included can be specified. From step 106, flow diagram 100 can continue with step 108.

Step 108 can include a planning and specification process. Planning can include, for example, floor plan layout selection. The specification process can typically require several meetings between the customer and the contractor. The customer can assist the contractor in selection of materials, fixtures and appliances.

The specification process of step 108 can require extreme detailed decisions to be made resulting in a specification including, e.g., fixtures, appliances (including manufacturers and model numbers), cabinetry, cabinet pulls, molding, and laminate colors. The specification process is a conventionally manual, time consuming process.

Conventionally, the contractor can spend much time interacting with the customer in the specification process. The pace of specification is largely up to the customer and the customer schedule, but can extend several weeks or more in duration. At the end of that time, the customer and the contractor can have a completed set of drawings and a complete set of specifications from which the project can be built. The customer can be given a more firm price for the renovation, for which the contractor can complete the project. From step 108, flow diagram 100 can continue with step 110.

Step 110 can include a construction and installation process. Once a contract is signed between the customer and contractor, there can be a several week period before construction can actually start. The construction process can include preliminary activities such as, e.g., ordering of materials, permits and job scheduling.

The construction process can include preparing a project timeline including steps involved in completing the project and a calendar. Conventionally this allows coordination by the contractor of materials, subcontractors and staff in order to manage the project. Job schedules can assist the customer in preparing for the inconveniences involved in the construction process. Unfortunately, construction projects can often run over schedule causing excessive customer frustration.

Prior to the time work actually begins on the project, the contractor can have a preconstruction meeting going over the timeline and making sure all preparations have been made so that the contractor can start. At this time the contractor can review the location of critical controls such as, e.g., electrical panel and water shut off, and disposition of existing cabinetry, fixtures and appliances. The contractor can also review site protection with the customer and review actions the customer can take to help reduce the effect on the customer's normal routine.

When work actually starts, the crew can spend time protecting non-impacted areas and screening off the work area to minimize the effect of construction on the rest of the customer's home. When satisfied protection is complete, so-called “tearout” can begin.

Following tearout, the construction project or job can progress from framing to completion. The process can include installation of fixtures and appliances. The typical project can take several weeks to several months to reach the point where the customer can move back into the newly renovated space. From step 110, flow diagram 100 can continue with step 112.

Step 112 can include a completion process. The renovation construction project can be considered to have reached the point of “substantial completion” when the renovated room is ready to be used for its intended purpose. This means that all fixtures and appliances are installed and working and contractor crews no longer visit the customer on a daily basis.

After the customer is able to use the new space for a few days, the contractor can walk through with the customer and prepare a so-called “punch list” of any items still needing attention and/or correction. When these items have been cleared, final payment can be due. From step 112, flow diagram 100 can continue end with step 114.

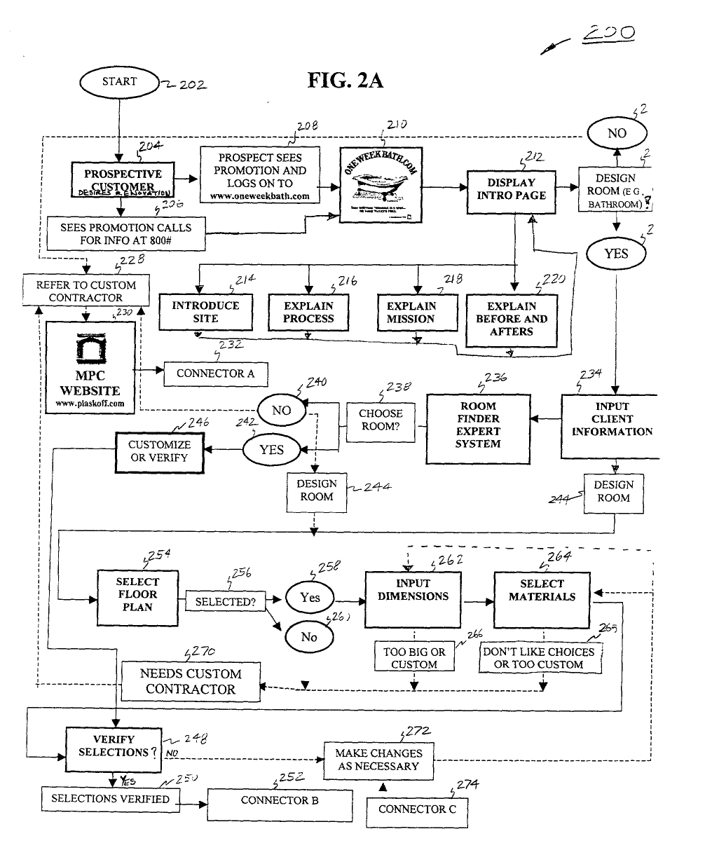

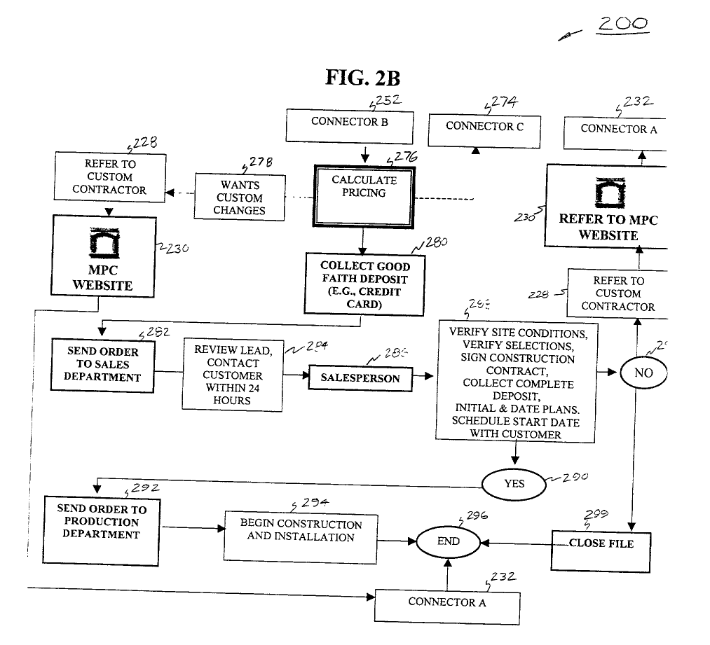

FIG. 2A and FIG. 2B, collectively, illustrate a flow diagram 200 depicting an example embodiment of the present invention. Flow diagram 200 begins with step 202 and continues immediately with step 204.

In step 204, a prospective customer can become interested in pursuing a renovation or remodeling project. From step 204, for diagram 200 can continue with step 206. In step 206, the prospective customer can see a promotion and can call for additional information at, e.g., an 800 number. In one embodiment of the invention, the prospective customer can be sent a packet including a questionnaire. The packet and questionnaire can describe the process of the present invention and guide the customer step by step through the process of designing, specifying, purchasing and seeking construction and installation of the renovation construction project. For example, where a prospective customer has no access to the Internet, the customer can use the packet and questionnaire to manually perform the customer-performed steps of the below described inventive process, where the packet and questionnaire can assist the customer in performing steps described further below in the context of performing the process using an alternative Internet interface. In accordance with the present invention, the prospective customer can, in an example embodiment, log on to a web site and input the data through an Internet interface as described below with reference to the remainder of flow diagram 200 of FIGS. 2A and 2B, collectively. Advantageously, the packets and questionnaire can guide the prospective customer through questions of the room finder expert system. From step 206, flow diagram 200 can continue with step 210.

Alternatively, from step 204, flow diagram 200 can continue with step 208. In step 208, the customer prospect can see a promotion and can then use an Internet browser to log on to a website that is configured to enable the customer to design, specify, purchase and seek construction and installation of, a construction renovation project. For example, the customer can log onto http:\\www.oneweekbath.com available from Oneweekbath, Inc., of Sherman Oaks, Calif., for example, to be able to design a bathroom. Alternatively, the customer can log onto http:†\www.twoweekkitchen.com to enable design and construction of a kitchen, also available from Oneweekbath, Inc., of Sherman Oaks, Calif. It will be apparent to those skilled in the art that alternative websites could be used to provide a fast and efficient means for designing, specifying, purchasing and constructing a construction renovation project such as, e.g., a living room, a deck, an addition, a sunroom, a porch, and garage. From step 208, flow chart 200 can continue with step 210.

In step 210, the customer can be presented with a home page such as that shown, i.e., oneweekbath.com. From step 210, flow diagram 200 can continue with step 212.

In step 212, an introductory page can be displayed on the customer's Internet browser. Examples of information that can be shown in the introductory page of step 212 are illustrated as steps 214, 216, 218 and 220.

In step 214, the website can be introduced including, e.g., identification of who is providing the renovation construction web site service. In step 216, a process for designing, specifying, purchasing and constructing a renovation construction project using the website can be explained. In step 218, the mission statement of the website can be explained. In step 220, examples of before and after views of, e.g., room renovations and floorplans can be shown and explained. It will be apparent to those skilled in the art that any of optional steps 214-220, and other steps, can be performed and displayed on the introductory page of the website of step 212. From step 212, flow diagram 200 can continue with step 222.

In step 222, a decision can be determined by querying the customer as to whether and as to what kind of room the customer would like to design. Advantageously, according to the present invention, the customer can choose to design the customer's room, or can use a room finder expert system to obtain an automatic room design recommendation, as described further below with reference to step 236. Advantageously, using the present invention, the customer can select from lists of options, or can use the room finder expert system to answer questions and based on the answers given, the room finder expert system can recommend one or more room designs, selecting options appropriately addressing the requirements as detailed in the customer's answers. In step 222, if the customer determines that they would like to design a room, they can continue with step 226. Alternatively, if the customer does not want to have to design the customer's own room, then flow diagram 200 can continue with step 224 which can immediately continue with step 228 to refer the customer to a custom contractor such as, for example, the contractor shown in step 230. In step 230, the customer can be linked through the customer's Internet browser to http://www.plaskoffcom, i.e., the website of Matt Plaskoff Construction, Inc., a custom contractor from Sherman Oaks, Calif. From step 230, flow diagram 200 can continue as shown at Connector A 232.

Beginning in step 226, the customer can be led through an example embodiment of a construction renovation design process. From step 226, flow diagram 200 can continue immediately with step 234. In step 234, the customer's client information can be inputted via the customer's Internet Browser, at, e.g., a customer's client computer, into a computer program that can transmit and store the information at, e.g., the contractor's website at, e.g., a contractor server computer. In step 234, contact information about the customer can be provided such as, e.g., name, address, and phone number. From step 234, the customer can choose to begin designing a room with step 244 of flow diagram 200, or using a room finder expert system in order to recommend design of the customer's own room, whereby flow diagram 200 can continue with step 236.

If the customer chooses to use the expert system to obtain a recommended room design, then flow diagram 200 can continue with step 236. In step 236, a room finder expert system can be used to guide the customer through a series of questions which can lead to a recommendation as to a room design. For example, the room finder expert system of step 236 can include a BATHFINDER as available from http://www.oneweekbath.com available from Oneweekbath, Inc., of Sherman Oaks, Calif. The BATHFINDER expert system of step 236, can use an artificial intelligence inference engine and/or knowledge base to arrive at a recommended room design depending on answers inputted by the customer in response to questions prompted by the expert system to the customer. Examples of questions that can be asked by the BATHFINDER in order to come to a recommendation of a room design, can include questions such as, e.g., whether the room is to be used as a rental; whether the owner desires the room to have a particular level of maintenance as in low maintenance or requiring greater maintenance, whether the room is intended for use by children, whether the room is to use a particular form of design such as contemporary or modern. In one example embodiment, based on the answers provided by the customer to the expert system of step 236, particular options can be selected by the knowledgebased inference engine expert system and can be recommended to the customer. It will be apparent to those skilled in the relevant arts, that other expert systems can be provided to guide a customer through design of other rooms such as, e.g., kitchens, decks, and others. From step 236, the flow chart 200 can continue with step 238.

Since the room finder expert system of step 236 can provide one or more recommendations to the customer, in step 238, the customer can choose to take one of the one or more of the recommended rooms. In one embodiment of the present invention, the room expert system can provide 3 room design recommendations. If in step 238, the customer agrees to take one of the recommended rooms, then flow diagram 200 can continue with step 242. In the alternative, if the customer in step 238 does not choose to take one of the one or more recommended rooms, then the flow diagram 200 can continue with step 240. In step 240, the customer can be queried to determine whether they would like to be referred to a custom contractor or whether they would like to design the customer's own room. If the customer designates that it would like to be referred to a custom contractor, then flow diagram 200 can continue with step 228. If the customer instead would like to design a room, then flow diagram 200 can continue with step 244. In step 238, if the customer decides to select one of the one or more recommended room designs, then in step 242, flow diagram 200 can continue immediately with step 246.

In step 246, the customer can be prompted to customize or verify the selections recommended by the room finder expert system of step 236. From step 246, flow diagram 200 can continue with a verified selection step 248.

In step 248, the customer can verify the selections of the room design. If the customer verifies and approves the selections, then flow diagram 200 can continue with step 250. If the customer does not verify the selections, then flow diagram 200 can continue with step 272.

In step 250, with the selections verified, flow diagram 200 can continue with Connector B 252.

In step 248, if the customer does not verify the selections that have been made, then flow diagram 200 can continue with step 272. In step 272, the customer can make changes as necessary to the selected design including modifying dimensions, materials, and other features of the renovation construction project design. FIG. 2A also depicts Connector C 274 which is connected directly to step 272 of flow diagram 200.

Referring now to step 244 of flow diagram 200. In step 244, the customer can design a room using the advantageous technique of the present invention. In one embodiment, step 244 can continue immediately with step 254.

In step 254, the customer can select a floor plan from a series of exemplary graphical representations of floor plans. In one embodiment, several high level depictions of floor plans can be displayed to the customer, and the customer can then select the high level depiction most similar to the room the customer is attempting to renovate. In one embodiment of the invention, the step 254 including selecting a floor plan can include, e.g., selecting a floor plan for the “as built” room. In one embodiment of the invention, the step 254 including selecting a floor plan can include, e.g., selecting a floor plan for the “as renovated” room. In one embodiment of the invention, the step 254 including selecting a floor plan can include, e.g., selecting a floor plan for the “as built” and “as renovated” room. In one embodiment, for example, one high level depiction could show a bathroom having only a sink and toilet; another high level depiction could show a bathroom having a sink, toilet, and shower stall; and another high level depiction could show a bathroom having a sink, toilet, shower stall and bathtub. It will be apparent to those skilled in the art that alternative depictions can be provided. Upon selecting the high level depiction most similar to the room “as built,” or “as renovated,” that the customer desires to renovate, additional more specific layouts of rooms similar to the high level room depiction, can be displayed, but, e.g., can be illustrated in different orientations, and variations. Then the customer can select the depiction of the room that most closely represents the room “as built” or as desired to be “as renovated.” From step 254, flow diagram 200 can continue with step 256.

In step 256, it can be determined whether the customer was able to select a floor plan that depicted the room “as built” and/or “as renovated.” If the customer in step 256 selects a room from the provided depiction, then flow diagram can continue with step 258. If in the alternative the customer does not select a room, then flow diagram 200 can continue with step 260 which can immediately continue with step 270 since the customer can desire a custom contractor to renovate the room in question. From step 270, flow diagram 200 can continue immediately with step 228.

In step 258, flow diagram 200 can continue immediately with step 262. In step 262, the customer can advantageously measure dimensions of the room and input the dimensions into the room designer program of the present invention using the customer's Internet browser. Advantageously, the room designer program, in one embodiment, can prompt the customer to input dimensions such as, e.g., length, width, dimensions of appliances, fixtures, and other useful dimensions. Once the dimensions have been inputted by the customer, the inputted data can be analyzed by the program and if the dimensions are determined to be too large or to require custom work, then flow diagram 200 can continue with step 266. In step 266, flow diagram 200 can continue immediately with step 270. In step 262, if the dimensions inputted are determined to be within acceptable threshold bounds, then flow diagram 200 can continue with step 264. In step 264, the customer advantageously, in one embodiment, can select materials for the renovation construction project including, e.g., appliances, cabinetry, fixtures, tile, and other materials required in renovating the selected room. In step 264, advantageously, the customer can select materials for the project from various alternative choices, including, e.g., choosing, e.g., size, dimension, style, and other features of the materials required for completion of the renovation. In step 264, advantageously, the customer can determine whether they like the options provided and, if so, can select to proceed to step 248 to verify their selections. In step 264, if the customer does not like the options provided as choices or would prefer to include custom features, then flow diagram 200 can refer the customer to a custom contractor and flow diagram 200 can continue immediately with step 270.

Referring now to FIG. 2B, from Connector B 252, flow diagram 200 can continue with step 276, as shown.

In step 276, a price can be calculated for the selected and verified renovation construction project design. In step 276, the price can be displayed to the customer and the customer can determine whether the customer desires to proceed forward to deposit a good faith deposit and, if so, flow diagram 200 can then proceed to step 280. In step 276, if the customer determines that the customer would prefer to add custom changes to the design, then flow diagram 200 can continue with step 278.

In step 278, the customer can input custom changes desired and the changes can then be forwarded on to, and the customer can be referred to the custom contractor. From step 278, flow diagram 200 can continue with step 228 where the customer can be referred to a custom contractor. From step 228, flow diagram 200 can continue with step 230, referring the customer to the custom contractor's website, and can continue to Connector A 232 which can then immediately end with step 296.

If the customer, after reviewing the calculated pricing in step 276, decides that the customer desires that an upgrade be performed, in one embodiment, the customer can be prompted to select other optional features for the room in an upgrade step (not shown). The upgrade step can occur between step 276 and step 278, between step 276 and step 280, or between step 276 and step 272. In such an upgrade step, the customer could select several optional features that could be made available by the system of the present invention. In one embodiment, optional upgrades could be offered that could give the customer an option to select to agree to pay a price that could exceed a fixed price guarantee. For example, the customer could be informed that, e.g., special mounting of a sink, or expensive marble tile, could be accomodated and provided as options, but that an upper fixed price guarantee could have to be exceeded in order to provide the option. The customer could then be provided a price estimate incorporating the upgrade and could be given the opportunity to select to agree to pay a price exceeding the contractor's upper fixed price guarantee. Thus, the system could advantageously upsell the customer to upgraded options that could normally not be offered in providing an upper fixed price guarantee. In another embodiment, the system could accommodate the customer selecting an upgrade option that could require a longer installation time than promised in a fixed installation time guarantee. For example, the customer could select to purchase, e.g., an imported European porcelain tub that could require longer ordering and delivery time. Thus, the system could advantageously allow the customer to agree to waive particular guarantees in order to obtain custom-like, upgrades and changes, all without needing to refer the customer to a custom contractor such as shown in step 228. Upgrade options, therefore, in one embodiment, can be used to potentially improve, advantageously, the profit margin for the renovation construction project contractor's process of the present invention.

If in step 276, the customer determines, based, e.g., on review of the calculated price, that the customer would like to change the design of the renovation construction project in order to modify the design, or to increase or to decrease the price of the project, the customer can select to make changes as necessary to the project. If the desire to make changes is selected, flow diagram 200 can continue with step 274. In step 274, Connector C can continue immediately with step 272 in prompting the customer to make changes as necessary and can continue immediately with step 264 to select materials or alternatively to modify dimensions in step 262 of the design.

In step 280, a good faith deposit can be secured from the customer and can be collected, e.g., via a credit card, or the like. From step 280, flow diagram 200 can continue with step 282.

In step 282, the renovation order as created and associated with the collected good faith deposit of step 280, can, in one embodiment, be sent to a sales department of the renovation system. In one embodiment, an e-mail can be created including the pertinent inputted information including, e.g., customer information, and a cut list generated automatically from the customer's selected materials, plans and dimensions. From step 282, flow diagram 200 can continue immediately with step 284.

In step 284, in one embodiment, a representative of the sales department can review the lead, and can have a representative contact the customer within a responsive time period, such as, e.g., 24 hours. From step 284, flow diagram 200 can proceed with step 286. In step 286, a sales person can be sent a copy of the lead and can proceed to perform particular tasks including, e.g., tasks such as those described in step 288. From step 286, flow diagram 200 can continue with step 288.

In step 288, the sales person or another representative, in one embodiment, e.g., can verify site conditions, can verify customer selections, can obtain a signed construction contract by obtaining the customer's signature, can collect a complete deposit for the contracted renovation construction project, can obtain initials and a dated signature on the construction plans, and can obtain a schedule for a start date with the customer, for tear-down and commencement of construction and installation, of the selected and agreed to materials. In step 288, if the customer is qualified and has agreed to the terms stated by the sales person or representative, then flow diagram 200 can continue with step 290 and can continue immediately with step 292.

In step 292, the sales person or representative of the sales person, can send the renovation construction project order to a production department. Advantageously, the renovation construction project order can be assigned in one embodiment to a very efficient production team. In one embodiment, the production team can include two workers. From step 292, flow diagram 200 can continue with step 294.

In step 294, construction and installation can begin. In one embodiment, construction of a bathroom can be completed in less than one week. In one embodiment, a kitchen can be completed in less than 2 weeks. In one embodiment, the contractor can guaranty completion within a set time period. In one embodiment, if the project does not complete within the guaranteed time period, the customer can be rewarded a discount from the contractor. For example, if a bath is guaranteed to be completed in a week and is not completed, then the contractor can, e.g., discount the price of the project by the price of the toilet. From step 294, flow diagram 200 can continue with step 296, which can immediately end.

In step 288, if the customer does not agree to the terms discussed by the sales person or representative, then the customer can be referred to a custom contractor as shown by flow diagram 200 continuing with step 298. In step 298, if the customer indicates that the customer would like to be referred to a custom contractor, then flow diagram 200 can continue with step 228. If, in the alternative, the customer indicates that the customer would prefer not to be referred to a custom contractor or that the customer has decided not to undertake the construction project, thus potentially losing any nonrefundable deposit, then the customer's file can be closed as illustrated in step 299, which can immediately end at step 296.

In step 228, the customer can be referred to a custom contractor as shown in step 230. In step 230, the customer can be referred to the custom contractor's website as shown in step 230, and flow diagram 200 can continue with Connector A 232, and can immediately end at step 296.

Advantageously, the renovation construction project process depicted in the example embodiment illustrated in flow diagram 200, can save substantial time and money for both the contractor and the customer. For example, the customer can efficiently review various alternative designs and can consider many manufacturers' fixtures and other materials for use in their renovation without the need to even leave the customer's home. Also, the customer, by investing the customer's time in inputting and gathering the data needed by the contractor, can obtain a substantial discount. For example, the contractor can afford to provide, special incentives, such as, e.g., a fixed price guarantee. Also, by performing some work conventionally performed by the contractor, the customer can benefit from a shorter length of time to complete construction. In one embodiment, the contractor can guarantee completion of construction within a fixed time period, such as, e.g., a bath in about a week or less, and a kitchen in about two weeks or less.

For the contractor, various efficiencies can be obtained, including, e.g., a room design can be automatically provided by the customer including, e.g., floor plan layouts, and room dimensions. Also benefitting the contractor, prior to investing in a meeting with the customer, the customer can be required in one embodiment to place a qualified good faith deposit to demonstrate the customer's interest in meeting with the contractor's sales person. The contractor also benefits from gaining a qualified sales lead by the use of the good faith deposit. In one embodiment, in step 280, a non-refundable good faith deposit of, e.g., $100 can be obtained from the customer and can be promised to be credited toward the payment of the price of the renovation construction project. The contractor also potentially can benefit by having the customer input the customer's own information including, e.g., name, address, telephone, and/or other contact information, and by the customer's input of, e.g., dimensions, room design selections, selection of specifications and features, material selections, other features, payment information, and can result in automated generation of reports including, e.g., a complete cut list of materials, fixtures, and cabinetry, and even a bill of materials, and capture and collection of deposit and fees by automated payment agreement. Advantageously, in one embodiment, the contractor can provide a fixed price contract and can guarantee completion of the renovation construction project in a fixed time period since the customer has minimized the amount of time required of the contractor to obtain, e.g., the inputs to manage designing, planning, specifying, pricing, constructing, and installing materials and providing in the end a cost-effective, high customer satisfaction level and a successful construction project.

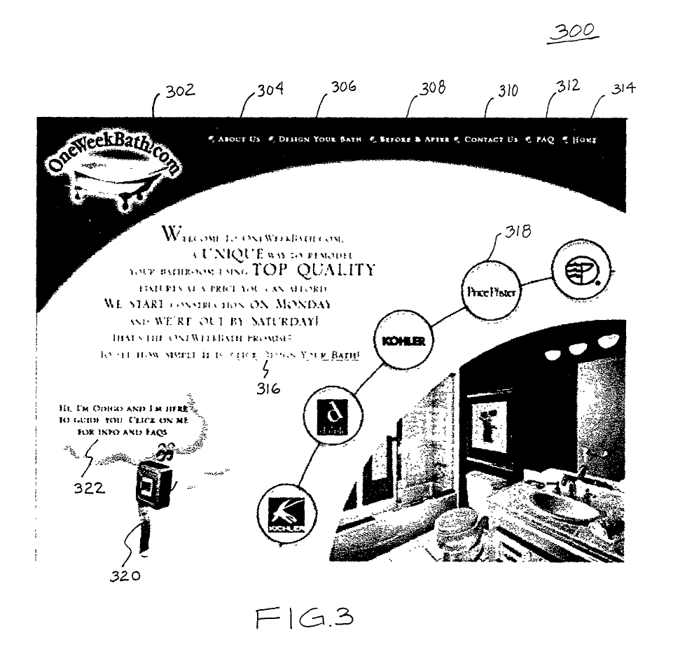

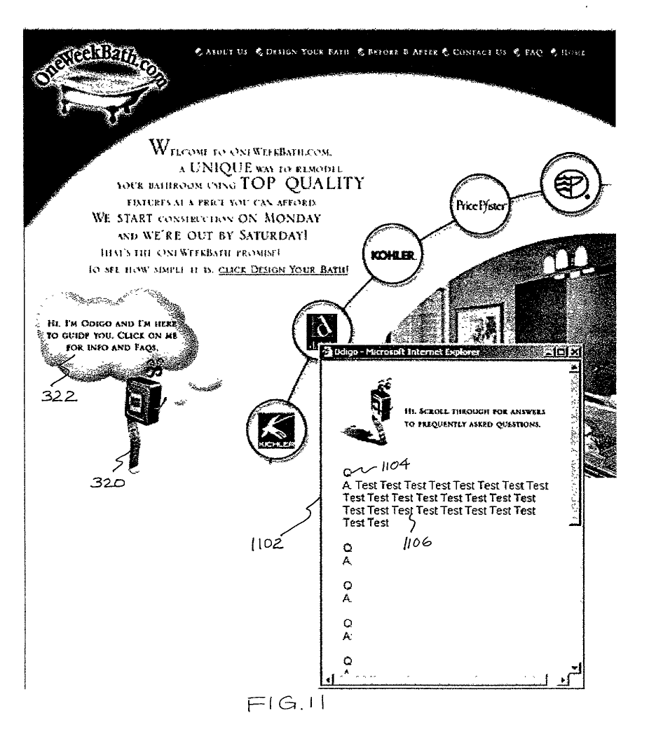

FIG. 3 depicts an exemplary embodiment of a graphical user interface (GUI) 300 illustrating an exemplary renovation design website. GUI 300 in an exemplary embodiment can include a brand logo 302 and various hyperlinks 304-316. Advertising space can be sold on the website including prominent advertising placement on the initial page such as, advertising logo 318, for example. Hyperlink about us 304 can link to additional information about the renovation design website. Hyperlink 306, in an exemplary embodiment can allow the user to begin designing the customer's renovation project. It is important to note that although the exemplary design system shown is used for designing a bathroom, it will be apparent to those skilled in the art that the system could have equally been used to design another type of renovation project. Before and after hyperlink 308 can allow the user to input information regarding the customer's prerenovation room and view the renovated design. Contact us hyperlink 310 can be used by the customer to access further information regarding the renovation design website. Hyperlink 312 can allow the user to access a frequently asked questions list as illustrated in pop-up window 1102 described further below with reference to FIG. 11. A home hyperlink 314 can appear on all pages of the renovation design website to return the customer to the initial homepage illustrated in FIG. 3. Hyperlinks to further helpful instructions 316 can be provided helping the user to understand the design methodology process. A useful guide 320 can be provided to instruct the user with messages 322 informing the user on how to proceed in designing a renovation project according an exemplary embodiment of the present invention.

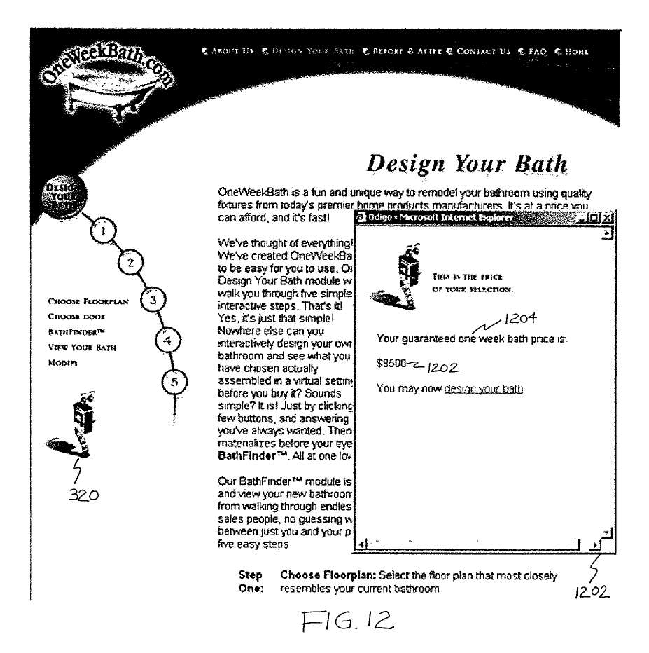

The odigo guide, in an exemplary embodiment can prompt the customer user to enter a zip code of the location of the renovation. Based on the zip code of the renovation, a database query can be performed to determine whether service coverage exists for the zip code region and if so, can provide an estimate of the cost of renovating the room. Specifically, in an exemplary embodiment, the Odigo guide can provide a pop-up window as shown in FIG. 12. In one exemplary embodiment, a fixed time period can be guaranteed. In another exemplary embodiment, a fixed price 1202 can be guaranteed for performing the renovation project.

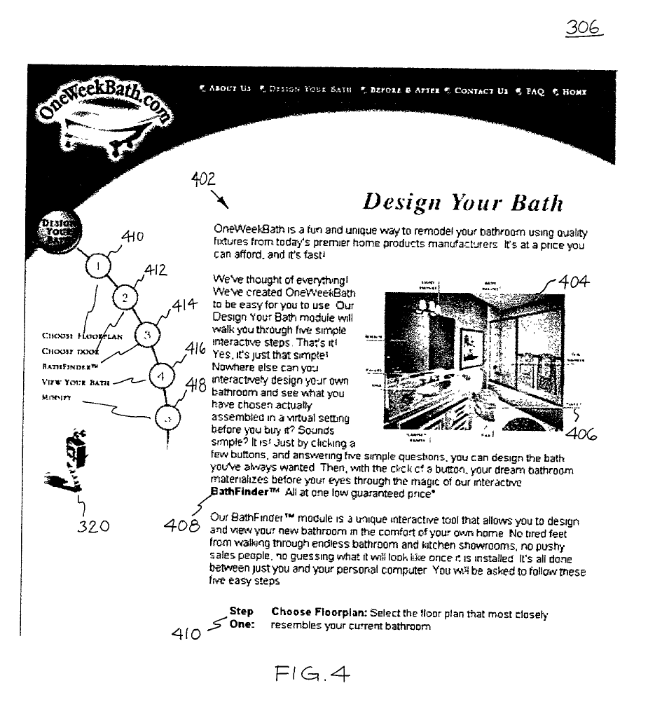

FIG. 4 depicts an exemplary embodiment of a GUI 306 illustrating an exemplary renovation design process of an exemplary implementation of the present invention. GUI 306, in an exemplary embodiment can include instruction text 402 and graphics 404 defining the elements of the design renovation including, e.g., labels 406 for different components of the renovation, in this case, a toilet.

The exemplary design process illustrated in GUI 306 includes a simplified five step process. The five step process depicted in GUI 306 includes step one 410, step two 412, step three 414, step four 416 and step five 418. Step one 410 can prompt a customer user to choose a floorplan. Step two 412 can prompt the customer user to choose a door location within the previously selected floorplan. Step three 414 can provide a room designer or room finder decision support system using an expert system that can include a knowledgebase of renovation design information. For example, a BATHFINDER™ system can be used to select a design for a bathroom according to user identified design element preferences. Step four 416 can allow the customer user to view the renovation design, in the exemplary embodiment, the bathroom designed in steps 410-414. In one exemplary embodiment, a three dimensional rendering of the renovated design can be depicted. Step five 418 allows the user to modify certain components of the design. In one exemplary embodiment, the renderings can be prerendered. In another exemplary embodiment, portions of the 3-D rendering can be individually rendered according to design selections or modifications and can be combined to depict an overall room rendering. Renderings of the entire room can be performed in one exemplary embodiment using software available from ARCHVISION of Louisville, Ky. USA.

The exemplary design process shown illustrates an exemplary simplified renovation design process according to one exemplary embodiment of the present invention. Various other exemplary design processes could be equally used within the spirit and scope of the present invention, as will be apparent to those skilled in the art.

A quick design process can alternatively be used by selecting the Bathfinder module 408, which advantageously leads the customer through a series of questions using a decision support expert system that inquires regarding various user preferences to arrive at a suggested renovation design. The Bathfinder module 408 is described further below with reference to GUI 414 of FIG. 7. If a user skips directly to the Bathfinder module 408, exemplary designs meeting the user's indicated preferences can be provided using default room floorplans and layouts. Alternatively, the user can follow sequentially the five step process beginning with step one 410.

The simplified design process illustrated in GUI 306 of FIG. 4 can begin with step one 410 which can allow a customer user to choose a floorplan of an unrenovated room that the customer seeks to renovate.

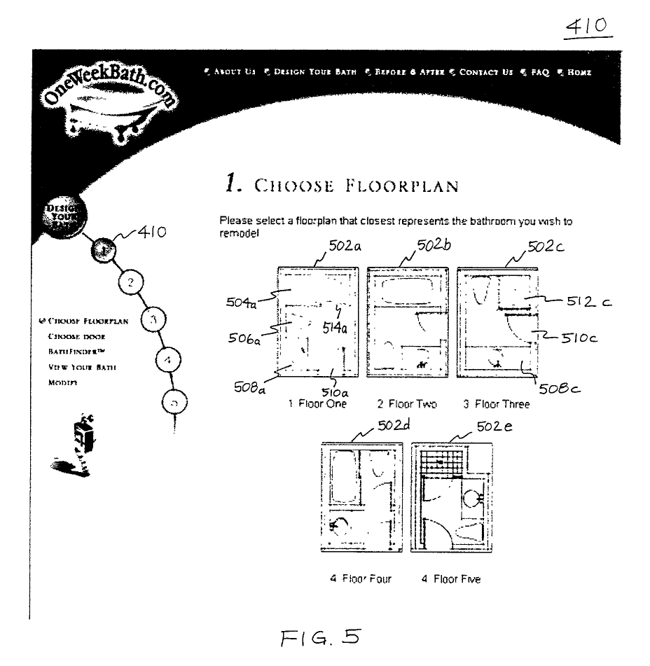

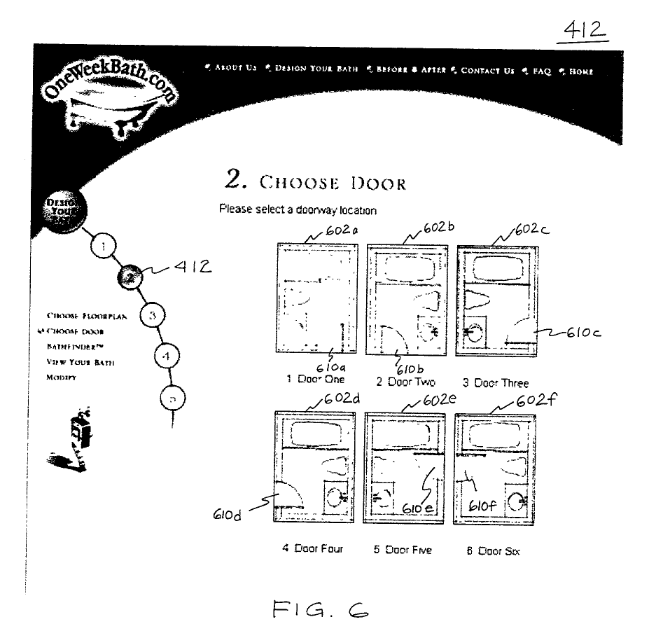

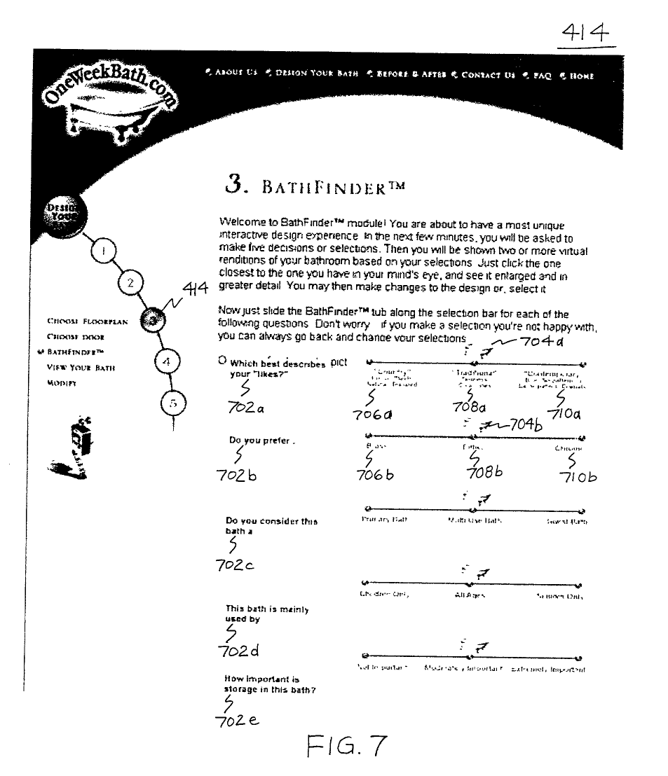

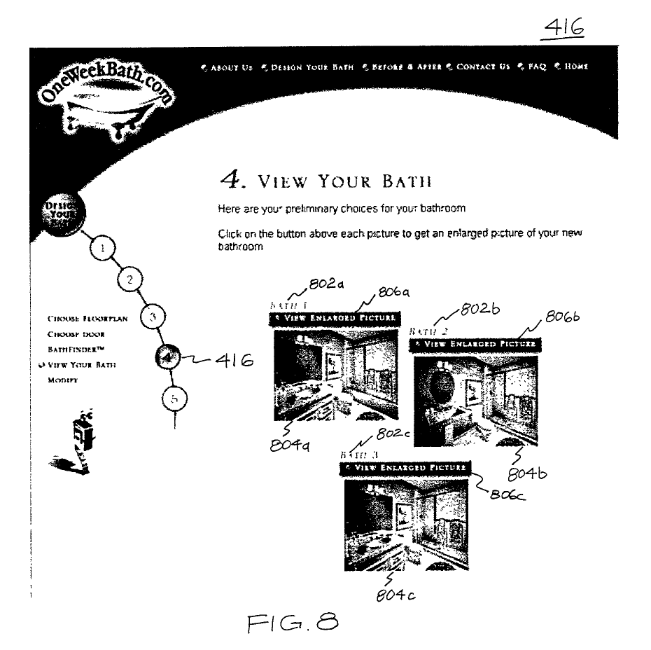

FIG. 5 depicts an exemplary embodiment of a GUI 410 illustrating an exemplary first step 410 of choosing a floorplan an exemplary renovation design process of an exemplary implementation according to the present invention. In the exemplary embodiment, multiple floorplans 502a-502e are depicted from which a user can select the floorplan 502 that most closely resembles the user's current floorplan. As illustrated, floorplan 502a in an exemplary embodiment can include a bathtub 504a with a sliding glass door 514a, a toilet 506a, a sink 508a, and a door 510a. Floorplan 502c, in an exemplary embodiment, can include a toilet 506c, a sink 508c, a door 510c, and a square standing shower 512c. Once the customer user has selected a floorplan, the customer user can then indicate an exact orientation and arrangement of the floorplan. From step one 410 of FIG. 5, a user can be presented with step two 412 of FIG. 6.

FIG. 6 depicts an exemplary embodiment of a GUI 412 illustrating an exemplary second step 412 of choosing a doorway location for the floorplan 502a selected in step one 410, according to an exemplary embodiment of the renovation design process of the present invention. In the exemplary embodiment of step two 412, various doorway locations 602a, 602b, 602c, 602d, 602e and 602f of doors 610a, 610b, 610c, 610d, 610e and 610f, respectively can be selected by the customer user. From the selections of steps 410 and 412, the database (not shown) of the present invention can determine where to locate all components of the renovation project in the design to be rendered. Advantageously, the database can be stored, in an exemplary embodiment, on a computer system separate from the customer user known as a server as will be apparent to those skilled in the relevant art. Alternatively, the database can be on a same or other computer system as the system being accessed by the customer user, where the other computer system can be coupled in some way to the customer user's computer system using, e.g., a network or the global Internet using conventional methods. In the exemplary embodiment of FIG. 2A, from selection of floorplans, a user can design their own renovation using steps 234, 235 or alternatively can use a room finder expert system 236 to select a design. In another exemplary embodiment, for simplicity, only a room finder expert system 236 such as, e.g., the BATHFINDER TM system available from Oneweekbath.com and Matt Plaskoff Construction of Tarzana, Calif., USA can be used to determine a design for the room renovation as described further below with reference to FIG. 7. In yet another exemplary embodiment, only custom design by the customer user of a renovation can be performed after completion of step 412 of FIG. 6.

FIG. 7 depicts an exemplary embodiment of a GUI 414 illustrating an exemplary third step 414 of providing an interactive decision support system for prompting the customer user to input user preferences using an exemplary BATHFINDER™ roomfinder expert system 236 process of an exemplary implementation embodiment according to the present invention. Exemplary questions 702a, 702b, 702c, 702d and 702e can prompt the customer user for preference information. Advantageously, as shown, a user can using a sliding indicator 704a-e to indicate which of a plurality of available preference choices 706, 708, 710 placed along a continuum. Although three choices 706-710 are provided for each question 702a-e, it will be apparent to those skilled in the art that any number of choices 706-710 can be provided, including, e.g., a single blank for entry of a choice, 2, 3, 4, 5, . . . , 10, . . . 100, or even more, from which to receive the customer user selection. In one exemplary embodiment only a limited number of questions 702 can be prompted such as, e.g., 2, 3, 4, 5, 6, 7, 8, 9, 10, or even more from which to arrive at a suggested design. For example, a user can select from a series of choices of styles of furniture such as, e.g., country 706a, traditional 708a, and contemporary 710a. Other exemplary preferences can be selected from choices such as, e.g., brass 706b, chrome 710b, and either 708b. In an exemplary embodiment, a positive interest can be captured, i.e., a preferred feature, such as, e.g., a two-faucet sink. In another exemplary embodiment, a negative interest can be captured, such as, e.g., a lack of desire for a shower curtain. Based on the selections made by the customer user in step 414 of FIG. 7, then the database can store all preferences of an associated customer user and can use the user's selections o calculate a recommendation. Using a knowledgebase, expert system, or neural network, (that to determine a design recommendation. In one exemplary embodiment, various rules related to renovation design can be captured from experts and using known artificial intelligence methods can be compiled within the knowledgebase or expert system. A cognitive engine can be used to yield a design recommendation. In one exemplary embodiment, a design recommendation as shown in step 416 of FIG. 8 can be depicted.

FIG. 8 depicts an exemplary embodiment of a GUI 416 illustrating an exemplary fourth step 416 providing an exemplary selection of alternative design renderings 802. In the exemplary embodiment, three exemplary design renderings 802a-802c are shown. (Any number of other exemplary design renderings could be provided to the customer user for selection.) The three virtual renderings 802a-802c of the exemplary embodiment of the invention are shown including thumbnail renderings 804a-804c, respectively, and links to view enlarged pictures 806a-c, respectively. In one exemplary embodiment, the renderings 802a-802c can have been pregenerated or prerendered. Alternatively, the renderings can be generated automatically depending on the results of the preferences captured in the step 414 of FIG. 7. In an alternative embodiment, where a user enters the user's own design, as depicted in an exemplary embodiment in step 234 and 235 of FIG. 2A, above, then the renderings can be generated to correspond to the combination of design features selected by the customer user. In one exemplary embodiment, the customer user can then select one preferred rendering 802a from the alternative renderings 802a-802c offered for selection. Alternatively, the expert system can score the designs according to rules and can recommend a single rendering 802a, or a list of renderings 802 in a ranked order.

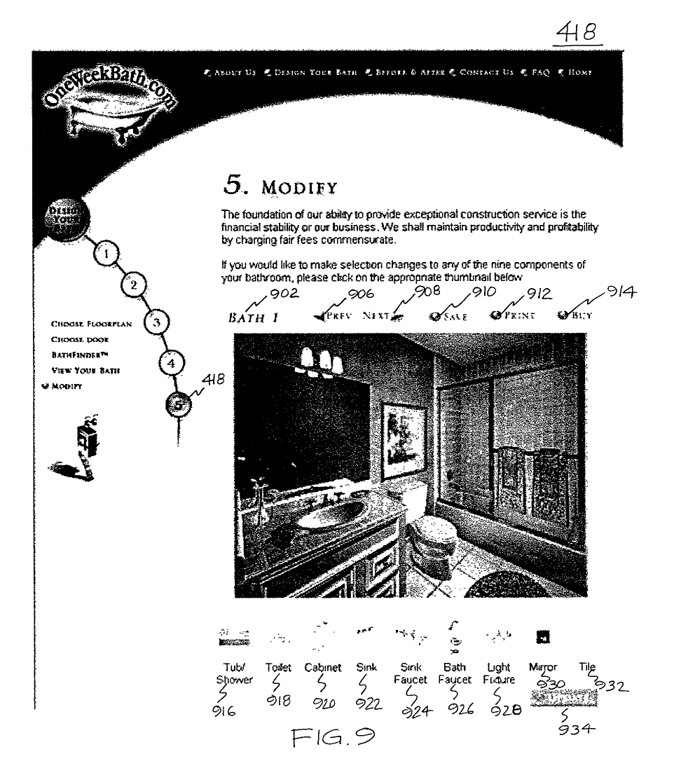

FIG. 9 depicts an exemplary embodiment of a GUI 418 illustrating an exemplary fifth step 418 of allowing user modification of an exemplary selected renovation design rendering 902 that could have been selected from a list of recommended selections. Advantageously, rendering 902 can include a larger graphical image rendering 904. In one exemplary embodiment, buttons 906 and 908 can allow the customer user to select another rendering 904, or advance forward and back through a series of other alternative renderings 904.

In one exemplary embodiment, the rendering can be saved for later access using button 910. In one exemplary embodiment, any or all of the information entered by the user customer from the beginning of the process can also be stored. The data can be stored in one exemplary embodiment on a customer user's personal storage device. In another exemplary embodiment, the data can be stored on a storage device separate from the customer user's personal storage system such as, e.g., on a server or a storage area network (SAN), compact disc (CD), or other media.

In an exemplary embodiment, the rendering can be printed using print button 912.

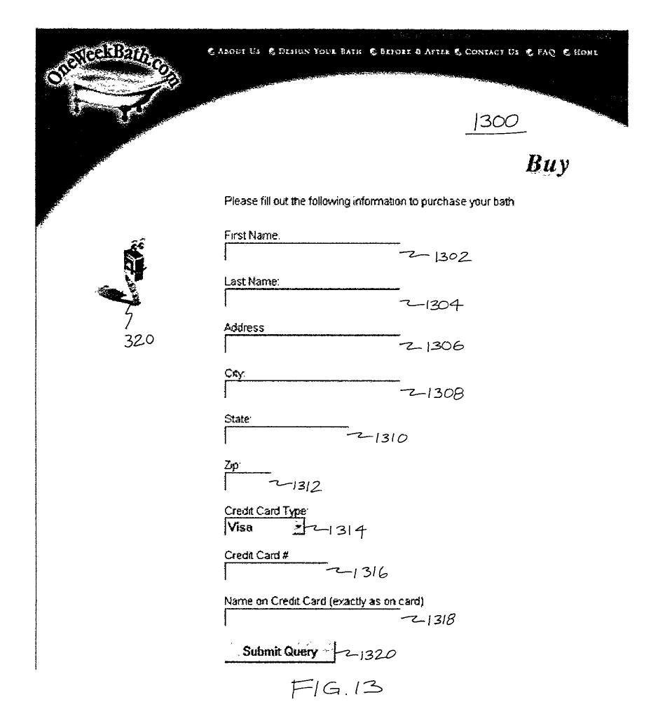

In another exemplary embodiment, the design once in a state where the customer user is satisfied with the result, can be purchased by having the user select the buy button 914. Selection of button 914, in an exemplary embodiment, can cause a form 1300, as shown in FIG. 13, to be provided to the customer user, prompting the user for additional information that can be inputted and transmitted to the service provider. In an exemplary embodiment, the information can be provided using a secure connection to protect the customer user's personal private information.

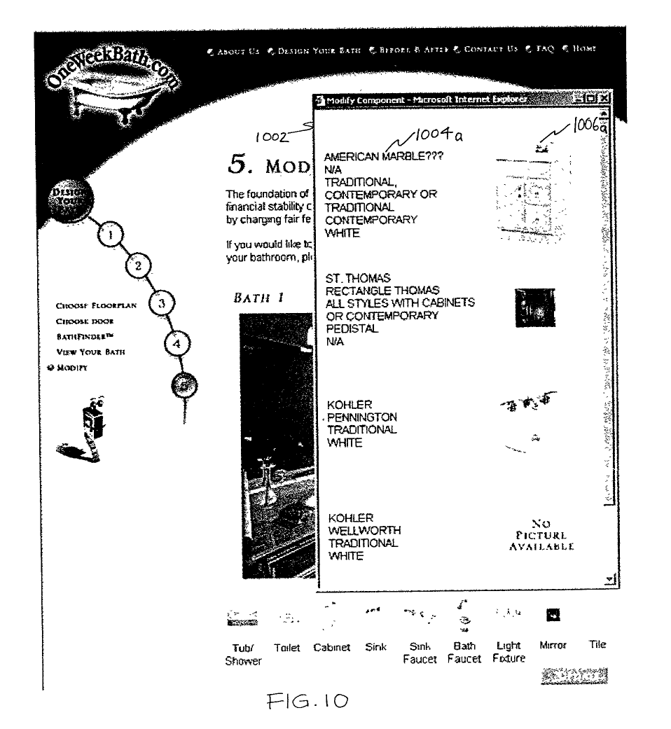

In an exemplary embodiment, FIG. 9 can also include icons 916-932. Icons 916-932 can allow the customer user to get further information about the components of the design. User selection of sink 922, for example, can allow a pop-up window 1002 as shown in FIG. 10 to appear. Other exemplary design components are shown and include in the exemplary embodiment, tub/shower 916, toilet 918, cabinet 920, sink 922, sink faucet 924, bath faucet 926, light fixture 928, mirror 930, and tile 932. In an exemplary embodiment, the customer user can select the component, see information about the selected component, can modify the selection by choosing from alternative selections and can then store the modified changes to the selected components. To view a new rendering, in an exemplary embodiment, an update button 934 can be selected. In an alternative embodiment, the rendering can be automatically updated upon selection of a different component. In an exemplary embodiment, the virtual rendering 904 can be prerendered using all permutations and combinations of options available for selection in the system. This prerendered exemplary embodiment can allow for quick access to renderings without the necessity to perform the numerical calculations involved in 3-dimensional (3-D) rendering. Alternatively, in another exemplary embodiment, different components of the rendering can be rendered so-called “on-the-fly” using, e.g, software applications such as, e.g., Archvision by design available from Archvision of Louisville, Ky., USA. Advantageously using rendering on the fly can allow a customer user to virtually “shop” for the exact features that the user wants in the design and as those features are selected, a new rendering can be automatically generated. In an exemplary embodiment, once all modifications are complete, the user can then store the resulting rendering using save button 910, and/or can print a hardcopy of the rendering using button 912, and/or the user can undertake to purchase the renovation of the design using buy button 914. In an exemplary embodiment, descriptions of each component item and other information about each design component can be viewed, stored, or printed.

FIG. 10 depicts an exemplary embodiment of a GUI pop-up window 1002 illustrating an exemplary modification step that can include a list of sinks 922 or other design components from a catalog of design components. Various information 1004a can be shown regarding each item 1006a of the list.

FIG. 11 depicts an exemplary embodiment of a GUI pop-up window 1102 illustrating an exemplary help resource including a frequently asked question list that can include, in an exemplary embodiment, a series of questions 1104 and associated answers 1106. Specifically, in an exemplary embodiment, the Odigo guide 320 can provide other prompts 322 and when selected can provide a pop-up window 1102 including frequently asked questions (FAQs).

FIG. 12 depicts an exemplary embodiment of a GUI pop-up window 1200 illustrating an exemplary help resource providing a guaranteed cost and time duration. The odigo guide 320, in an exemplary embodiment, can, e.g., prompt the customer user to enter a zip code of the location of the renovation. Based on the zip code of the renovation, a database query can be performed to determine whether service coverage exists for the zip code region and if so, can provide an estimate of the cost of renovating the room. The Odigo guide 320 can be used to determine a price and estimated time for construction of the project. In one exemplary embodiment, a fixed time period can be guaranteed. In another exemplary embodiment, a fixed price 1202 can be guaranteed for performing the renovation project.

FIG. 13 depicts an exemplary embodiment of a GUI form 1300 illustrating exemplary web form including fields 1302-1318. Fields 1302-1318, e.g., can capture customer information that can include, e.g., a customer order to provide an initial consultation fee that can be charged to a credit card for example. Use of the form can also allow for prompt scheduling of an initial visit with an estimator, consultant or salesperson. In on e exemplary embodiment, an initial consultation fee of, e.g., $100 can be charged to the client. Selection of button 914, in an exemplary embodiment, can cause form 1300 to appear. Form 1300 can be used to prompt the user for additional information that can be inputted by the customer user and can be transmitted to the service provider. In an exemplary embodiment, the information can be provided using a secure connection to protect the customer user's personal private information. Thus, GUI 1300 can be used to capture demographic information about the customer user. Advantageously, the GUI 1300 can also be used to solicit financing services to the user. For example, in an exemplary embodiment, home equity financing can be applied for using, e.g., a website such as, e.g., a bank, or a home equity e-lender such as, e.g., www.home123.com.

Advantageously, following transmission of a purchase request from the customer user, the estimator/consultant can meet with the user and using, e.g., a notebook computer can revise the customer's order/design and ultimately can print and have the customer user execute (i.e., sign) the contract. Other information can also be captured such as, e.g., a schedule for start of the project. Various exemplary templates can be used to guide the estimator/consultant/salesperson through finalizing a contract, exemplary templates are discussed below. Ultimately, the system according to the present invention can generate automatically an order including a list of parts including information such as, e.g., quantities, SKUs, and other descriptive information that can be ordered directly from a retailer/distributor such as, e.g., a Home Depot, or Lowes, for example. The service provider can transmit the order to the retailer/distributor and can follow-up to ensure that the order is ready and complete with all needed parts including prerequisite and corequisite/associated parts and accessories. Then a crew can pick up the completed order from the retailer/distributor and can travel to the work site to begin work. In an exemplary embodiment, instructions including directions as can be generated by mapping software such as, e.g., MAPQUEST, can be used to provide easy to follow directions for the crew to visit the site. Advantageously, in an exemplary embodiment, tutorials, and step by step instructions can be provided and quality control templates can guide the crew through the installation yielding a completed project in a far shorter time, within a far lesser cost, using a much smaller crew than is conventionally needed.

Operation Templates

In an exemplary embodiment of the present invention, various templates or outlines can be generated by the present invention and can be provided to field consultants, salespeople, or the members of a crew. Examples of useful documents can include, e.g., an order selection sheet; a general vehicle requirements; general pallet requirements; data materials listings; a customer selection sheet; consultant field measurement forms; replacement reference guide; installation procedure questions and concerns; tutorial manuals for estimators/consultants; installation procedures for preparing a standard bath or other renovation; installation procedures and progress reports; tool requirement inventories; customer satisfaction checklists; terms and conditions of contract; initial visit and pricing fee; additional time required for alterations; an inventory listing for customer orders; catalogs of various potential fixtures/components; and quantity scales for ordering. Any or all of these forms can be automated, interactive, or can be integrated into a backend database and can be provided to the customer, salesperson/estimator, customer service person, or crew member. For quality control purposes, a franchise system can be created that can require that franchisees use all the systems, and forms of the present invention to manage the renovation process.

The order selection sheet can be generated as a result of capturing the data inputted by the customer into the interactive design system of the present invention. Upon manifesting intent to buy, the customer's order can automatically generate an order selection sheet capturing all the customer's specific requests.

The general vehicle requirements template or form can include an inventory of all items that can be included onboard the truck that can be used by the crew. For example, if the crew needs additional piping or fittings, then by accessing the form on the crew's notebook computer, the crew can determine whether a needed component or part is available on the truck.

The customer's design selections can also generate advantageously a cutsheet with a list of items. For example, general pallet requirements and data materials listings can be included.

The customer selection sheet, in an exemplary embodiment can include the customer's order as captured and can also include the contract executed by the customer.

Various forms can be provided to estimators/customer service representatives which can be discussed with the customer. For example, the consultant field measurement forms can be used by the customer service agent/estimator/consultant in consulting with the customer. Another tool that can be provided to the consultant can include a replacement reference guide providing alternative exchanges that can be provided to the customer. Installation procedures can include various questions and answers for customer and crew concerns.

A tutorial manual can be provided for the estimator/consultants. In one exemplary embodiment, training videos can be provided.

Operating lists can be provided to the crew which can be used for quality control and as documentation of the processing steps. In an exemplary embodiment reports can be prepared and downloaded into the crewmember's computing device. For example, a digital camera can be used to document before, during and after, including locations of pipes and electrical wiring before drywalling, for example. Various aspects of the construction project can be captured and stored. Later, recordable compact discs (CDs) can be burned providing a fixed documentation of various aspects of the job. By documenting the process, at a later date this information can be used by the contractor in litigation and by management to maintain quality control.

Installation procedures for preparing a standard bath or other renovation can be provided using an interactive automated form. The form can lead the crew through the construction process using a best practices methodology. Forms can be used to track and provide to the crew installation procedures and progress reporting (which can be include digital camera capture of various stages of the construction renovation project.

Automated forms can access a database and can include inventories of supplies and tools for which crew teams can be held responsible.

The customer satisfaction checklist can include an automated punchlist by which the customer can acknowledge that all services were adequately performed and/or delivered. The automated capture of the transaction can be documented and accessed through the database. A customer begins a transaction record that gets modified by the estimator and eventually becomes a contract with terms and conditions that can be executed by the customer. The terms and conditions of the contract, including any special requests by the customer can be formalized and documented during the initial visit meeting with the estimator/consultant. Pricing of fees, parts, and services can be captured and incorporated automatically into the contract.

A list of additional time required to provide other services or custom offerings above and beyond standard offerings that can cause the duration of the construction project to extend beyond the guaranteed time duration can be provided. Thus, revised time estimates can automatically be calculated and guaranteed according to a list of time requirements for specific lists of tasks and services.

An inventory listing of all parts, including manufacturer information, model numbers, descriptions, warranty and other similar useful information can be provided on the customer order.

An automated parts/fixtures catalog of various potential fixtures/components can be provided with a rich store of data regarding all components. The catalog can be tied into local suppliers and can include retailer SKUs for ease of ordering.

The quantity scales for ordering can include tables or automated tools that can provide calculations of related items that must be ordered. For example, when a part is selected by a customer, prerequisite and corequisite associated parts can be automatically added to a parts list to ensure that all necessary parts are ordered from the outset. The automated form can generate, e.g., a cutsheet including all necessary parts, supplies, labor requirements. For example, if eighty-seven square feet of tile are ordered, the automated form can automatically calculate the amount of grout that should be ordered associated with the tile.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for designing, specifying, purchasing and constructing a construction renovation project comprising the steps of:
(a) receiving a renovation order for a construction renovation project from a customer, wherein said renovation order is prepared by the customer including designing, specifying, and purchasing;
(b) delivering materials specified in said renovation order and needed to perform said construction renovation project to a renovation location specified of said construction renovation project; and
(c) performing construction services of said construction renovation project as specified in said renovation order at said renovation location.

2. The method of claim 1, further comprising the step of:
(d) completing said construction renovation project within a set time period or providing an award.

3. The method of claim 2, further comprising the step of:
(e) completing said construction renovation project at a fixed price.

4. The method of claim 1, further comprising the step of:
(d) completing said construction renovation project at a fixed price.

5. The method of claim 3, wherein said construction renovation project is for a bathroom.

6. The method of claim 5, wherein said set time period is one week.

7. The method of claim 5, wherein said award is a discount equivalent to the cost of a toilet.

8. The method of claim 5, wherein said fixed price is approximately $7,500.

9. The method of claim 3, wherein said renovation project is for a kitchen.

10. The method of claim 9, wherein said set time period is two weeks.

11. The method of claim 1, wherein said step (a) comprises:
receiving a request for a floorplan;
receiving a request for a doorway location;
receiving a selection from a roomfinder expert system;
receiving a request from recommended alternative designs;
sending a rendering at least one of said alternative designs;
receiving modifications to the alternative design yielding a modified design;
receiving an order to at least one of store, print and order said modified design.

12. The method of claim 11, wherein said modified design is rendered using at least one of pre-rendering and on-the-fly rendering.

13. The method of claim 1, wherein said step (a) comprises the step of:
(1) guiding the customer through a room design process using a room finder expert system, wherein the design process can include a series of questions regarding the room design, comprising the steps of:
(A) asking questions relevant to the room design;
(B) receiving selections of answers to said questions from the customer;
(C) analyzing said selections of answers from the customer using a room finder expert system;
(D) asking any additional questions relevant to the room design; and
(E) determining one or more recommendations of the room design for the customer.

14. The method of claim 13, wherein the room design is at least one of a bathroom and a kitchen.

15. The method of claim 1, wherein said renovation order is created by the customer at an Internet interface.

16. The method of claim 15, wherein said Internet interface comprises a world wide web Internet browser.

17. The method of claim 1, wherein said renovation order is created by the customer comprising filling out a packet questionnaire.

18. A method for guiding a prospective renovation construction customer through a room design process using a room finder expert system, wherein the design process can include a series of questions regarding the room design, the method comprising the steps of:
(a) asking questions relevant to the room design;
(b) receiving selections of answers to said questions from the customer;
(c) analyzing said selections of answers from the customer using a room finder expert system;
(d) asking any additional questions relevant to the room design; and
(e) determining one or more recommendations of the room design for the customer.

19. The method of claim 18, wherein the room design is at least one of a bathroom and a kitchen.

20. A system that designs, specifies, purchases and constructs a construction renovation project comprising:
a receiver module that receives a renovation order for a construction renovation project from a customer, wherein said renovation order is prepared by the customer including design, specification, and purchase and wherein said renovation order is created by the customer including use of at least one of an Internet interface and a packet questionnaire;
a deliverer that delivers materials specified in said renovation order and needed to perform said construction renovation project to a renovation location specified in said construction renovation project; and
a performer that performs construction services of said construction renovation project as specified in said renovation order at said renovation location.
